(19) United States
(12) Patent Application Publication
(10) Pub. No.: US 2003/0063593 A1
(43) Pub. Date: Apr. 3, 2003

(54) Wireless communication system and wireless LAN access point

(75) Inventors: Atsushi Koyanagi, Ome-shi (JP); Koichi Kaji, Hidaka-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/231,197

(22) Filed: Aug. 30, 2002

(30) Foreign Application Priority Data
Sep. 29, 2001 (JP) 2001-375031

(51) Int. Cl. H04Q 7/24

(52) U.S. Cl. 370/338

(57) ABSTRACT

This invention provides a wireless LAN communication system capable of separating a wireless LAN network at a data link layer level. This invention adds an identifier representing a network segment to a frame used in wireless communication. A wireless LAN client receives only data having an identifier which coincides with an identifier representing its own network segment. The wireless LAN network can be separated into a plurality of networks at a data link layer level within the same radio frequency band.

### CROSS-REFERENCE TO RELATED APPLICATIONS

This application is based upon and claims the benefit of priority from the prior Japanese Patent Application No. 2001-375031, filed Sep. 29, 2001, the entire contents of which are incorporated herein by reference.

### BACKGROUND OF THE INVENTION

1. Field of the Invention

The present invention relates to a wireless communication system including a wireless LAN client and wireless LAN access point.

2. Description of the Related Art

A conventional wireless LAN system using a wireless LAN access point can construct a plurality of networks within the same radio frequency band by assigning an IP address to each wireless LAN client so as to enable identifying each network.

For example, IP addresses “192.168.1.1” and “192.168.1.2” are respectively assigned to the first and second clients belonging to a network A. IP addresses “10.1.1.1” and “10.1.1.2” are respectively assigned to the first and second clients belonging to a network B.

“192.168.1” of the IP address of the client belonging to the network A represents a network address, and the least significant 1 byte represents a host address. That is, the network can be identified by the network address of the IP address.

A wired LAN has a VLAN (Virtual Local Area Network) switching hub corresponding to a VLAN. A network can be separated into a plurality of networks in accordance with the settings of the VLAN switching hub regardless of the IP address.

In the above prior art, a plurality of network addresses (network address parts of the IP addresses) are assigned to a single wireless LAN access point. This allows constructing a plurality of networks at a single wireless LAN access point.

Each network is identified in a network layer serving as the third layer in an OSI reference model, but is not identified in a layer lower than the third layer. When a protocol, e.g., NetBEUI (NetBIOS Extended User Interface), other than IP is used in the use of a protocol between the network layer and a data link layer serving as the second layer, a wireless terminal which has not acquired an IP address yet undesirably transmits a packet of a DHCP request (request for acquiring an IP address or the like) to other networks.

This poses a network operation problem such that a terminal present at a different network address responds, and a security problem such that a terminal in a different network can intercept a packet.

As a means to solve the above problems, the wired LAN has the VLAN switching hub which separates a network in the data link layer. However, to implement the same function as the VLAN switching hub, the wireless LAN needs to prepare access points using different radio frequencies for respective networks. Alternately, the wireless LAN requires an access point having a radio unit capable of using a plurality of radio frequencies simultaneously. This increases the cost.

### BRIEF SUMMARY OF THE INVENTION

The present invention has been made in consideration of the above situation, and has as its object to provide a wireless LAN communication system capable of separating a wireless LAN network at a data link layer level.

It is another object of the present invention to provide a wireless LAN access point, wireless LAN client, and wireless communication method used in the wireless communication system.

To achieve the above objects, according to a first aspect of the invention, there is provided a wireless communication system comprising a wireless LAN access point comprising a table which stores in association with each other a MAC address of a wireless communication terminal and segment information which represents a wireless network to which the wireless communication terminal belongs, embedding means for looking up the table, acquiring segment information of a target transmission wireless communication terminal, and embedding the acquired segment information in a frame, and transmission means for transmitting the frame in which the segment information is embedded by the embedding means, and a wireless communication terminal comprising reception means for receiving the frame transmitted by the transmission means, determination means for determining whether the segment information embedded in the frame received by the reception means coincides with segment information of the wireless communication terminal, and packet processing means for receiving a packet which contains the frame when the determination means determines that the received segment information coincides with the segment information of the wireless communication terminal, and discarding the packet which contains the received frame when the determination means determines that the received segment information does not coincide with the segment information of the wireless communication terminal.

According to a second aspect of the invention, there is provided a wireless communication terminal comprising reception means for receiving a frame which contains segment information which represents a wireless network transmitted by a wireless LAN access point, determination means for determining whether the segment information embedded in the frame received by the reception means coincides with segment information of the wireless communication terminal, and packet processing means for receiving a packet which contains the frame when the determination means determines that the segment information coincides with the segment information of the wireless communication terminal, and discarding the packet which contains the received frame when the determination means determines that the segment information does not coincide with the segment information of the wireless communication terminal.

According to a third aspect of the invention, there is provided a wireless LAN access point comprising a table which stores in association with each other a MAC address of a wireless communication terminal and segment information which represents a wireless network to which the wireless communication terminal belongs, segment information acquisition means for looking up the table to acquire segment information of the wireless communication terminal on the basis of an association request which contains the MAC address of the wireless communication terminal, first setting means for setting in a frame the segment information acquired by the segment information acquisition means, and transmission means for transmitting as an association response the frame in which the first setting means sets the segment information.

According to a fourth aspect of the invention, there is provided a wireless communication terminal comprising transmission means for transmitting an association request which contains a MAC address of the wireless communication terminal, reception means for receiving an association response which contains segment information which represents a wireless network, in response to the association request transmitted by the transmission means, and storage means for storing the segment information contained in the association response received by the reception means.

### BRIEF DESCRIPTION OF THE SEVERAL VIEWS OF THE DRAWING

FIG. 1 is a view showing the arrangement of a wireless communication system according to an embodiment of the present invention;

FIG. 2 is a block diagram showing the arrangement of a wireless LAN access point;

FIG. 3 is a table showing the relationship between a MAC (Media Access Control) address and the segment number of the MAC address;

FIG. 4 is a table showing the number of segments, the IP (Internet Protocol) address of the segment, and the subnet mask address of the segment;

FIG. 5 is a block diagram showing the arrangement of a wireless LAN client;

FIG. 6 is a view showing a data frame used in data transmission;

FIG. 7 is a view showing the subfield of a Frame Control field;

FIG. 8 is a table showing four communication forms;

FIG. 9 is a view showing the format of a management frame;

FIG. 10 is a table showing the Frame Body formats of Association Response and Reassociation Response;

FIG. 11 is a table showing a code set as a status code and the meaning of the code;

FIG. 12 is a view showing the format of a data frame used in the embodiment of the present invention;

FIG. 13 is a table showing the Frame Body formats of Association Response and Reassociation Response used in the embodiment of the present invention;

FIG. 14 is a flow chart for explaining a segment distribution method;

FIG. 15 is a flow chart of a wireless LAN client;

FIG. 16 is a flow chart when the wireless LAN client receives data;

FIG. 17 is a flow chart when the wireless LAN client transmits data; and

FIG. 18 is a timing chart of the wireless communication system according to the embodiment of the present invention.

### DETAILED DESCRIPTION OF THE INVENTION

A wireless communication system according to an embodiment of the present invention will be described below with reference to the several views of the accompanying drawing.

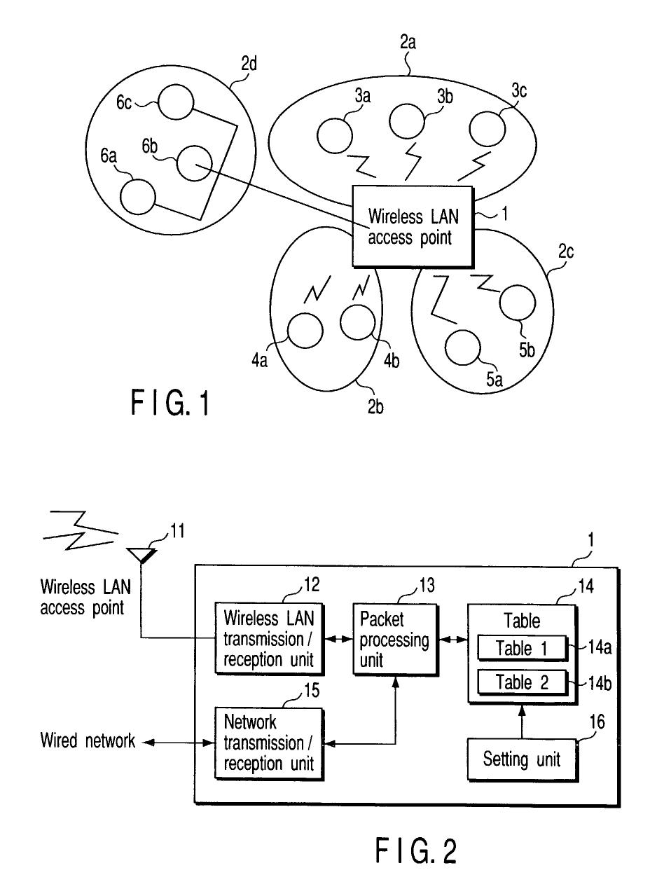

FIG. 1 is a view showing the arrangement of the wireless communication system according to the embodiment of the present invention.

FIG. 1 shows a case wherein a wireless LAN access point 1 separately manages three network segments 2a to 2c.

The network segment 2a has wireless LAN clients 3a to 3c, the network segment 2b has wireless LAN clients 4a and 4b, and the network segment 2c has wireless LAN clients 5a and 5b. The wireless LAN access point 1 is connected to a wired LAN network 2d. In this case, the wired LAN network 2d is connected to wired LAN clients 6a to 6c.

FIG. 2 is a block diagram showing the arrangement of the wireless LAN access point. As shown in FIG. 2, the wireless LAN access point 1 comprises an antenna 11, wireless LAN transmission/reception unit 12, packet processing unit 13, table 14, network transmission/reception unit 15, and setting unit 16. The table 14 comprises two tables 14a and 14b.

Wireless communication in this embodiment is performed in accordance with IEEE 802.11. However, the present invention is not limited to this and can also be applied to other wireless communication methods.

The wireless LAN transmission/reception unit 12 transmits/receives packet data to/from the wireless LAN network through the antenna 11.

The packet processing unit 13 performs processing of the wireless LAN access point, e.g., processing of reception data transmitted from the wireless LAN transmission/reception unit 12 and processing of data transmitted to the wireless LAN client.

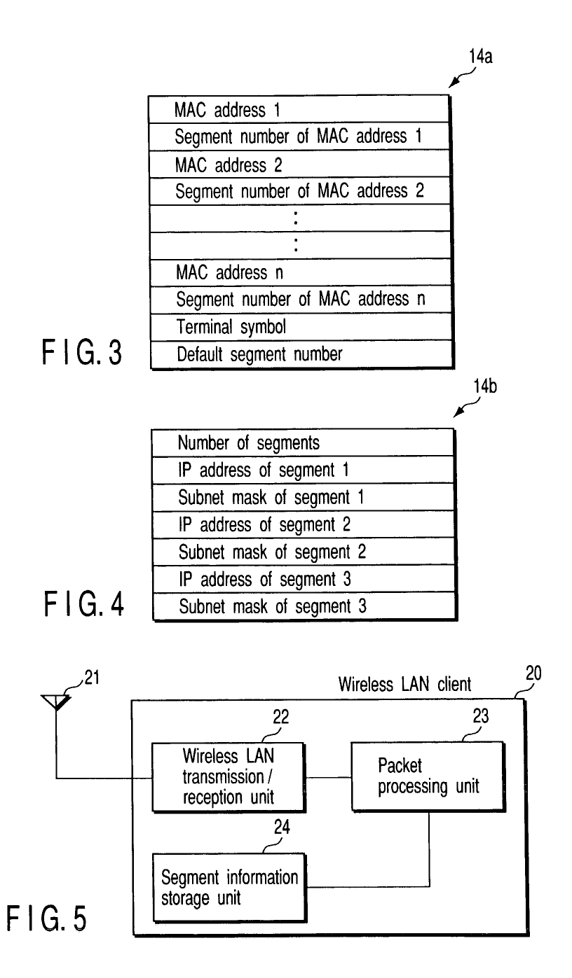

The table 14 has the two tables 14a and 14b. FIG. 3 shows the table 14a, and FIG. 4 shows the table 14b.

The table 14a is a table showing the relationship between MAC (Media Access Control) addresses and the segment numbers of the MAC addresses. “MAC address” represents the address of a wireless LAN client, and “segment number of a MAC address” represents the segment number of a network segment to which a wireless LAN client represented by a corresponding MAC address belongs.

Note that as “terminal symbol” in FIG. 3, a MAC address that does not represent a unique device, e.g., a hexadecimal number “FFFFFFFFFFFF” is used. “Segment number” represents connection rejection=0, segment=1, segment=2, segment=3, . . .

The table 14b stores the number of segments, the IP (Internet Protocol) addresses of the segments, and the subnet mask addresses of the segments. The IP addresses and subnet mask addresses of the segments are paired and stored.

The network transmission/reception unit 15 transmits/receives a packet through a wired network such as Ethernet, ADSL, or the like.

The setting unit 16 sets and changes the contents of the tables 14a and 14b. In this embodiment, network segments to which wireless LAN clients belong can be separated by setting the segment numbers of MAC addresses in the table 14a. Consequently, a plurality of networks can be separately managed in the wireless LAN network.

The wireless LAN access point in this embodiment may have a routing function between the network segments 2a, 2b, and 2c and the wired LAN network 2d. In addition, various services (DHCP server function, RARP server function, and the like) may be provided in the wireless LAN access point 1.

FIG. 5 is a block diagram showing a wireless LAN client.

As shown in FIG. 5, a wireless LAN client 20 has an antenna 21, wireless LAN transmission/reception unit 22, packet processing unit 23, and segment information storage unit 24.

The wireless LAN transmission/reception unit 22 transmits/receives data through the antenna 21.

The packet processing unit performs processing of checking whether to receive data input from the wireless LAN access point 1 through the wireless LAN transmission/reception unit 22, and processing for data transmitted to the wireless LAN access point.

The segment information storage unit 24 stores segment information which is transmitted from the wireless LAN access point, and represents a network segment to which the wireless LAN client 20 belongs.

A frame used in the wireless LAN access point according to the embodiment of the present invention will be described.

In this embodiment of the present invention, an improvement of a frame complying with IEEE 802.11 is used.

A portion of the frame used in IEEE 802.11 that is relevant to the present invention will be briefly described first. The meaning of each field of the data frame based on IEEE 802.11 is described in IEEE 802.11.

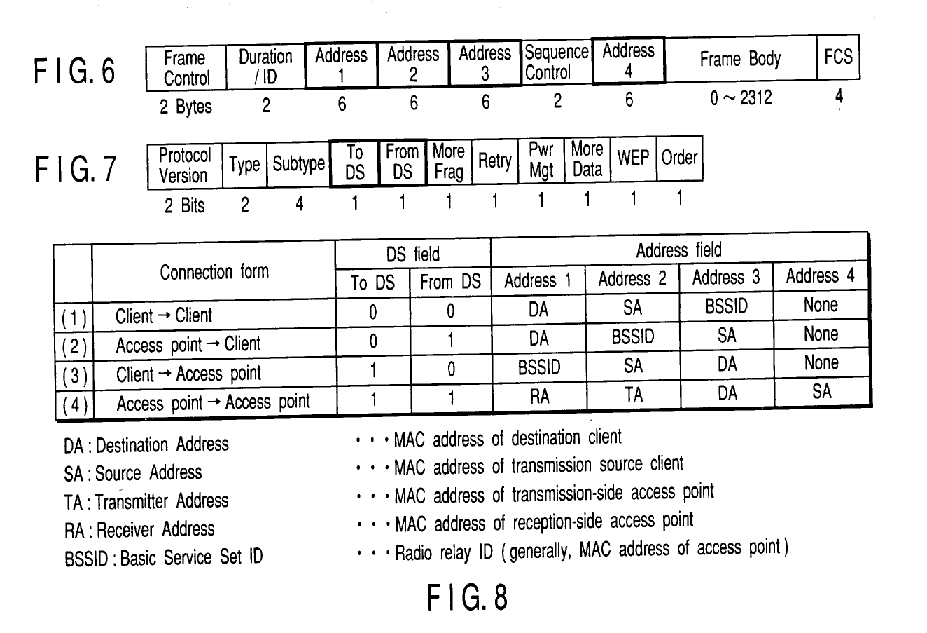

FIG. 6 is a view showing a data frame used in data transmission. A Frame Control field in FIG. 6 is constructed by subfields as shown in FIG. 7.

When a network is to be constructed by a number of wireless LAN clients, a wireless LAN access point is generally used to concentratedly manage communication between the clients or to connect the network to a network using another transmission medium (e.g., Ethernet or ADSL).

IEEE 802.11 defines the use of four communication forms. The four communication forms are, in brief, (1) client→client, (2) access point→client, (3) client→access point, and (4) access point→access point. When an access point exists, the form (1) is not used generally. Values assigned to four Address fields shown in FIG. 6 are defined as shown in FIG. 8 depending on a combination of these communications.

In this case, “DA (Destination Address)” is the MAC (Media Access Control) address of a destination client; “SA (Source Address)”, the MAC address of a transmission source client; “TA (Transmitter Address)”, the MAC address of an access point on the transmission side; “RA (Receiver Address)”, the MAC address of an access point on the reception side; and “BSSID (Basic Service Set ID)”, a radio relay ID (generally, the MAC address of an access point).

In FIG. 8, the connection forms (1) to (3) do not have the Address 4 field. In addition, destination and transmission source addresses in a radio section are assigned to the Address 1 and 2 fields, respectively.

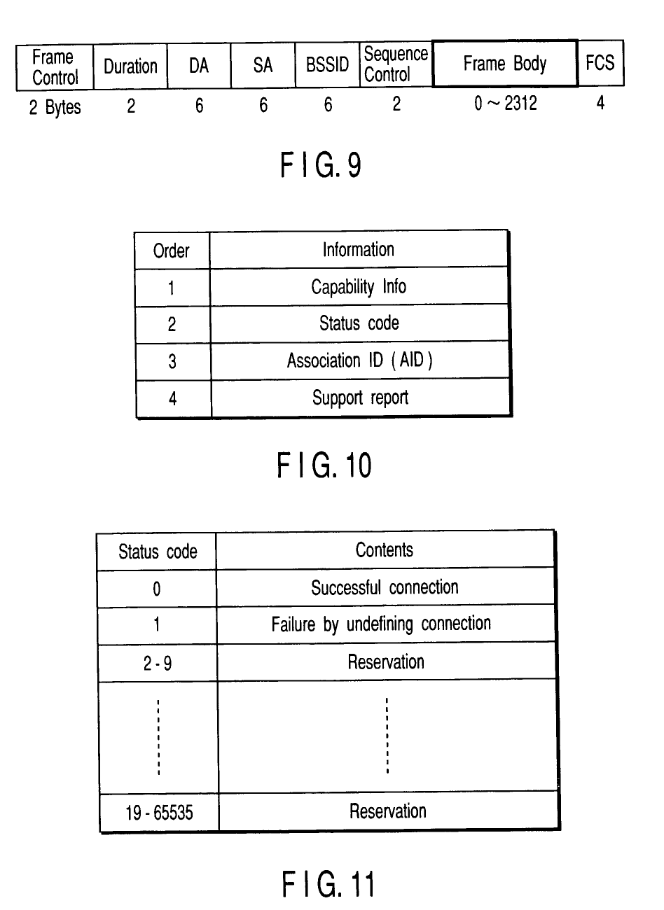

A management frame used for authentication, connection, and the like between a client and an access point will be briefly described next. FIG. 9 is a view showing the format of the management frame.

To enable a client to communicate with an access point, a process called Association is needed. Association is performed by the following procedure. When the client transmits Association Request, the access point determines from information whether the client can be connected, and then returns Association Response.

For roaming, or reconnection by changing setting information, the client that has been performed Association with an access point sometimes wants to perform Association with another access point (or the same access point).

In this case, the client transmits Reassociation Request. The access point then responds to the client by transmitting Reassociation Response, thus performing Reassociation. Association Request and Association Response are contained in Frame Body of the management frame and transmitted.

Association Response and Reassociation Response have a common Frame Body format, as shown in FIG. 10. In successful connection, “0” is set in the status code of the Frame Body format shown in FIG. 10. When connection fails, another code that represents the reason of the connection failure is set. FIG. 11 is a table showing codes set in the status code and the meaning of each code.

A frame format used in the wireless communication system according to the embodiment of the present invention will be described.

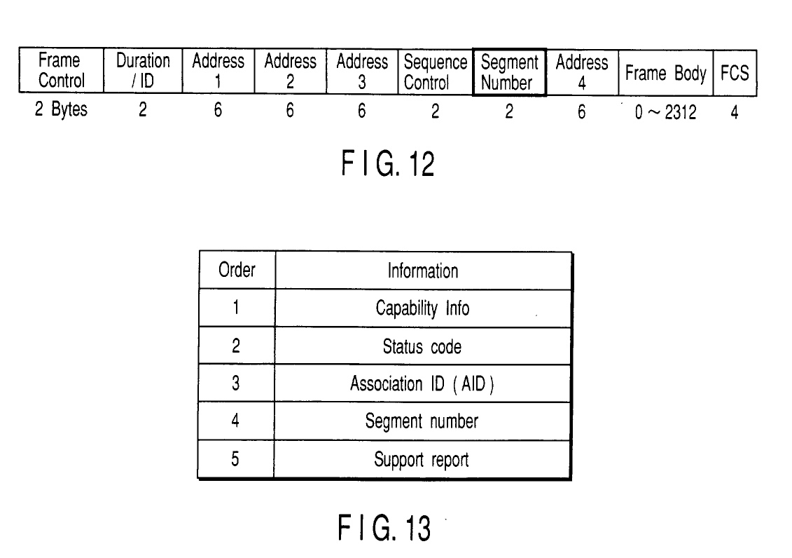

FIG. 12 is a view showing the format of a data frame used in the embodiment of the present invention. In this embodiment, to separate broadcast domains with the same radio frequency band, as shown in FIG. 12, the format of the data frame has a segment identifier “Segment Number” in addition to the data frame based on IEEE 802.11 shown in FIG. 6. As for the management frame, as shown in FIG. 13, the segment identifier “segment number” is added to Frame Body of the management frame of Association Response or Reassociation Response shown in FIG. 10.

The operation of the wireless communication system according to the embodiment of the present invention will be described.

<Segment Number Distribution>

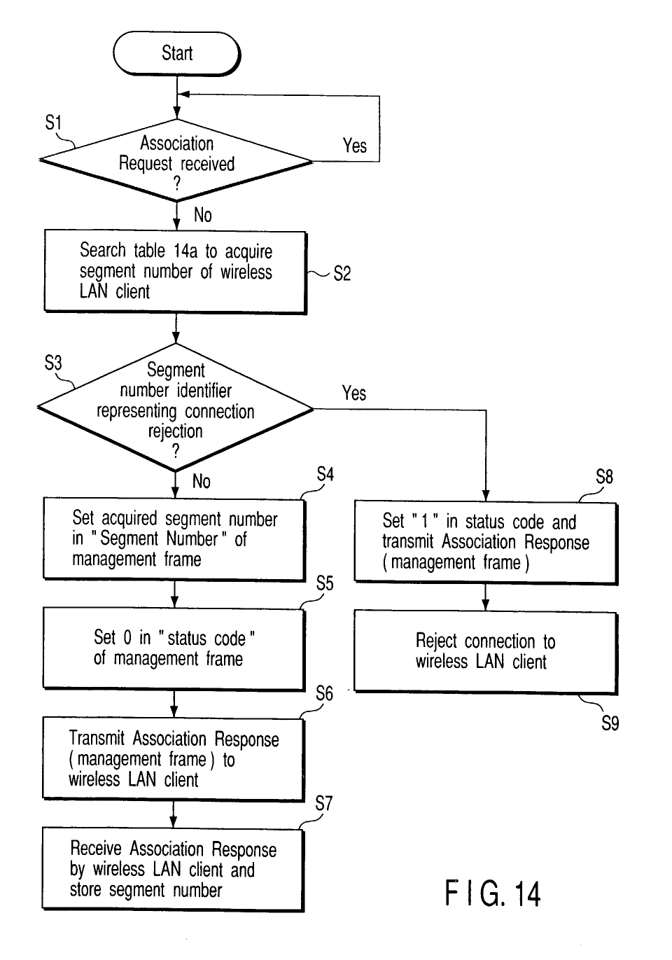

First, a method of distributing a segment number from a wireless LAN access point to a wireless LAN client will be described with reference to the flow chart shown in FIG. 14.

The wireless LAN access point checks whether it has received Association Request (or Reassociation Request) from a wireless LAN client (S1).

If Yes in S1, the wireless LAN access point searches the table 14a for a MAC address which coincides with the MAC address of the wireless LAN client, and acquires a segment number (S2) in order to determine a segment where the wireless LAN client which has transmitted this Association Request is to be assigned. If no coinciding MAC address exists, a default segment number is used.

The wireless LAN access point checks whether the segment number acquired in S2 is an identification number representing connection rejection (S3). If No in S3, the acquired segment number is set in “segment number” of the management frame (S4).

Subsequently, the wireless LAN access point sets “0” representing successful connection in the status code of the management frame (S5). Association Response (or Reassociation Response) is transmitted to the wireless LAN client by using the management frame (S6).

The wireless LAN client which has received Association Response from the wireless LAN access point determines that Association with the segment represented by the assigned segment number is performed, and stores the received segment number (S7). With this operation, the segment number is transmitted from the wireless LAN access point to the wireless LAN client.

If Yes in S3, a code “1” representing failure by undefining connection is set in the status code, and Association Response (or Reassociation Response) is transmitted by using the management frame (S8). Then connection to the wireless LAN client is rejected (S9).

By executing the aforementioned operation, the segment number is distributed to the wireless LAN access point.

<Data Distribution from Wireless LAN Access Point>

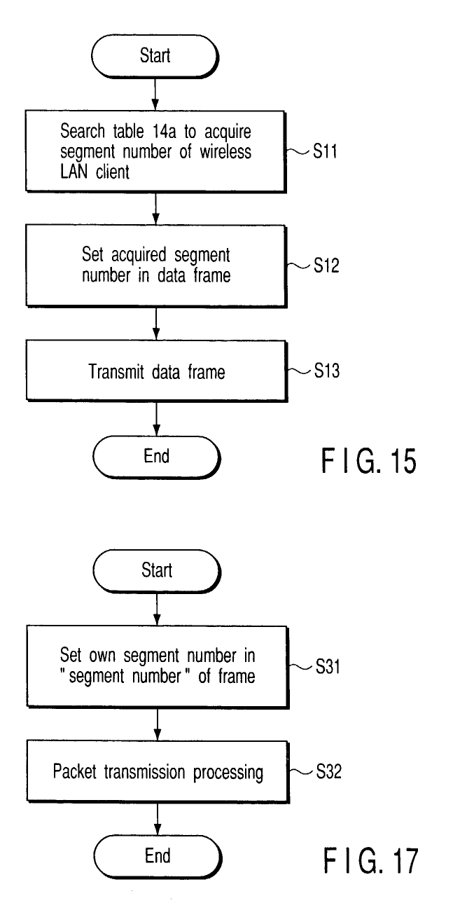

A case wherein a packet such as a response to a service request, or a packet for routing to another segment is to be transmitted from the wireless LAN access point to the wireless LAN client will be described with reference to the flow chart shown in FIG. 15.

The wireless LAN access point looks up the table 14a to acquire the segment number of the MAC address of a target transmission wireless LAN client (S11).

The wireless LAN access point sets the acquired segment number in “Segment Number” of the data frame (S12), and transmits the data frame containing the segment number (S13). As the transmission source IP address of an IP packet in a network layer, an IP address coinciding with the segment to be transmitted is searched for from the table 14b and is used.

<Wireless LAN Client Operation>

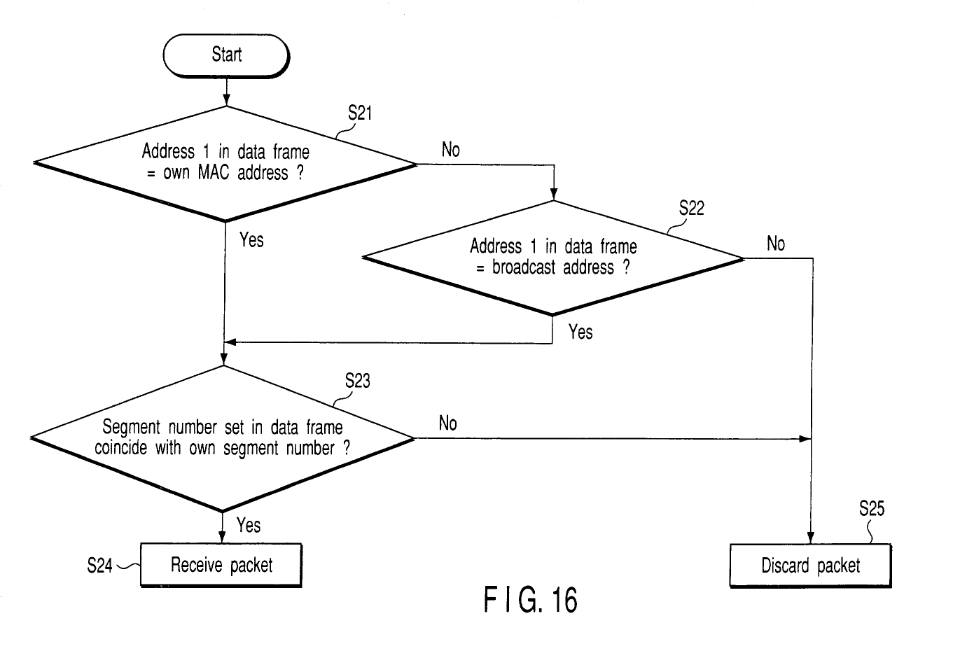

A case wherein the wireless LAN client receives data will be described with reference to the flow chart in FIG. 16.

Upon receiving a data frame, the wireless LAN client checks whether Address 1 in the data frame represents its own MAC address (S21). If No in S21, whether Address 1 in the data frame represents a broadcast address is checked (S22).

If Yes in S22 or S21, whether the segment number set in the data frame coincides with its own segment number that is transmitted from the wireless LAN access point and stored is then checked (S23).

If Yes in S23, the wireless LAN client receives a packet containing this data frame (S24).

If No in S22 or S23, the packet containing this data frame is discarded (S25).

With this operation, the wireless LAN client receives only a packet containing a frame representing its own segment. The wireless LAN network can be separated in a data link layer.

When the wireless LAN client is to transmit data, it sets its own segment number in “Segment Number” of a data frame (S31) and performs packet transmission processing (S32), as shown in the flow chart of FIG. 17.

Note that as for receiving the management frame, the wireless LAN client receives data only when DA (MAC address of a destination client) in the management frame coincides with its own address, like the prior art.

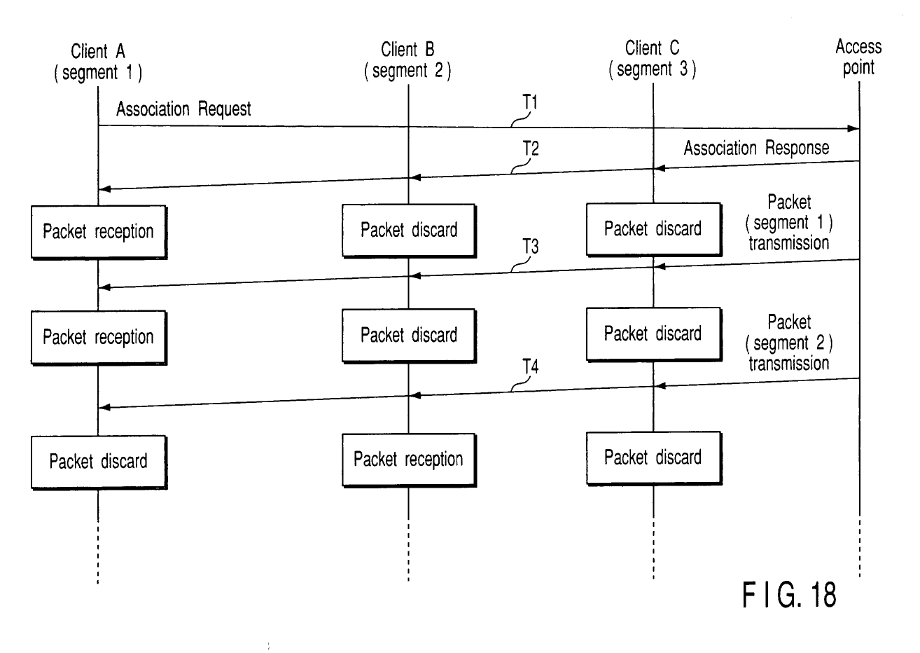

FIG. 18 is a timing chart for explaining the operation of the wireless communication system of the present invention.

The operation will be described on the assumption that wireless LAN clients A to C belong to segments 1 to 3, respectively.

When a wireless LAN client is located in the network of segment 1, Association Request is transmitted from the wireless LAN client A to a wireless LAN access point (T1).

The wireless LAN access point receives Association Request from the wireless LAN client A. If connection is successful, the wireless LAN access point acquires the segment number of the wireless LAN client A from the table 14a and transmits Association Response in which the acquired segment number is set (T2).

In this case, since the MAC address of the wireless LAN client A is set in DA of Association Response, the wireless LAN clients B and C do not receive the packet containing this Association Response, and discard it.

The wireless LAN client A acquires segment number 1 from Association Response and stores this segment number.

Subsequently, when the wireless LAN access point transmits data to the wireless LAN client A, the wireless LAN access point sets a destination address to the MAC address of the wireless LAN client A and transmits a packet (T3). The packet contains a data frame in which segment number 1 representing the segment to which the wireless LAN client A belongs is set.

In this case, segment 1 serving as the segment of the wireless LAN client A is set in the data frame. Accordingly, the wireless LAN clients B and C respectively belonging to segments 2 and 3 do not receive the packet containing this data frame, and discard it. To the contrary, the wireless LAN client A receives the packet containing the data frame.

When the wireless LAN access point is to transmit data to the wireless LAN client B belonging to segment 2, it sets segment number 2 in the data frame and transmits a packet by using the MAC address of the wireless LAN client B as a destination address (T4).

With this operation, this packet is received only by the wireless LAN client B. The wireless LAN clients A and C respectively belonging segments 1 and 3 do not receive this packet.

Therefore, the wireless communication system of this embodiment can separate networks using the same radio frequency band at the data link layer level by setting an identifier representing a network segment in each frame.

In addition, the wireless LAN access point can set a combination of wireless LAN clients freely by changing the contents of the table of the wireless LAN access point.

Further, a specific wireless LAN client can be prevented from entering the network by changing the contents of the table of the wireless LAN access point.

The present invention is not limited to the above-described embodiment, and can be variously modified without departing from the spirit and scope of the invention in practical use.

As has been described in detail above, the present invention can provide a wireless LAN communication system capable of separating wireless LAN networks at the data link layer level.

The present invention can also provide a wireless LAN access point, wireless LAN client, and wireless communication method used in the wireless communication system.

What is claimed is:

1. A wireless communication system comprising:
a wireless access point comprising
a table which stores segment information which represents a wireless network group to which the wireless communication terminal belongs,
means for embedding the segment information of target transmission wireless communication terminal in a frame according to the table, and
means for transmitting the frame; and
a wireless communication terminal comprising
means for receiving the frame transmitted by said transmission means,
means for determining whether the segment information embedded in the frame received by said reception means coincides with segment information of said wireless communication terminal, and
means for receiving a packet which contains the frame when said determination means determines that the received segment information coincides with the segment information of said wireless communication terminal.

2. The system according to claim 1, further comprising means for discarding the packet which contains the received frame when said determination means determines that the received segment information does not coincide with the segment information of said wireless communication terminal.

3. The system according to claim 1, wherein the frame includes a data frame.

4. The system according to claim 1, wherein
said determination means determines whether a destination address in the frame coincides with a MAC address of said wireless communication terminal, and
said packet processing means receives a packet which contains the frame when the segment information embedded in the received frame coincides with the segment information of said wireless communication terminal, and the destination address in the frame coincides with the MAC address of said wireless communication terminal.

5. The system according to claim 1, wherein
said determination means determines whether a destination address in the frame is a broadcast address, and
said packet processing means receives a packet which contains the frame when the segment information embedded in the received frame coincides with the segment information of said wireless communication terminal, and the destination address in the frame coincides with the broadcast address.

6. A wireless communication terminal comprising:
means for receiving a frame which contains segment information which represents a wireless network group;
means for determining whether the segment information embedded in the frame received by said reception means coincides with segment information of said wireless communication terminal; and
packet processing means for receiving a packet which contains the frame when said determination means determines that the segment information coincides with the segment information of said wireless communication terminal.

7. The terminal according to according to claim 6, further comprising means for discarding the packet which contains the received frame when said determination means determines that the segment information does not coincide with the segment information of said wireless communication terminal.

8. A terminal according to claim 6, wherein
said determination means determines whether a destination address in the frame coincides with a MAC address of said wireless communication terminal, and
said packet processing means receives a packet which contains the frame when the segment information embedded in the received frame coincides with the segment information of said wireless communication terminal, and the destination address in the frame coincides with the MAC address of said wireless communication terminal.

9. A terminal according to claim 6, wherein
said determination means determines whether a destination address in the frame is a broadcast address, and
said packet processing means receives a packet which contains the frame when the segment information embedded in the received frame coincides with the segment information of said wireless communication terminal, and the destination address in the frame coincides with the broadcast address.

10. A wireless access point comprising:
a table which stores segment information which represents a wireless network group to which the wireless communication terminal belongs;
means for setting in a frame the segment information of the wireless communication terminal on the basis of the table; and
means for transmitting the frame.

11. The point according to claim 10, further comprising means for looking up the table to acquire segment information of the wireless communication terminal on the basis of an association request which contains the MAC address of the wireless communication terminal.

12. The point according to claim 10, which further comprises
means for determining whether the segment information acquired by said segment information acquisition means is information which represents connection rejection, and
means for setting in a frame an identifier which represents connection rejection when said determination means determines that the acquired segment information is information which represents connection rejection, and
in which said transmission means transmits as an association response the frame in which said second setting means sets the identifier which represents connection rejection.

13. A wireless communication terminal comprising:
means for transmitting an association request which contains a MAC address of said wireless communication terminal;
means for receiving an association response which contains segment information which represents a wireless network, in response to the association request transmitted by said transmission means; and
means for storing the segment information contained in the association response received by said reception means.

14. A wireless communication method at a wireless LAN access point comprising a table which stores in association with each other an address of a wireless communication terminal and segment information which represents a wireless network to which the wireless communication terminal belongs, comprising:
setting the segment information of the wireless communication terminal in a frame on the basis of the table; and
transmitting the frame.

15. A method according to claim 14, further comprising
determining whether the acquired segment information is information which represents connection rejection, and
setting in a frame an identifier which represents connection rejection when the acquired segment information is determined to be information which represents connection rejection, and transmitting as an association response the frame in which the identifier which represents connection rejection is set.

16. A wireless communication method in a wireless communication terminal, comprising:
receiving from a wireless LAN access point a frame which contains segment information which represents a wireless network;
determining whether the segment information embedded in the received frame coincides with segment information of the wireless communication terminal; and
receiving a packet which contains the frame when the segment information is determined to coincide with the segment information of the wireless communication terminal, and discarding the packet which contains the frame when the segment information is not determined to coincide with the segment information of the wireless communication terminal.

17. A wireless communication terminal comprising:
means for wirelessly communicating with a wireless access point;
means for storing group identification information which is notified from the wireless access point, and used to identify a wireless network to which said wireless communication terminal belongs; and
means for looking up said storage means and adding the group information to transmission data when the wireless communication terminal is to transmit the transmission data through said wireless communication means.

18. A wireless communication terminal comprising:
means for wirelessly communicating with a wireless access point;
means for storing group identification information which is notified from the wireless access point, and used to identify a wireless network to which said wireless communication terminal belongs; and
means for receiving/discarding reception data on the basis of group identification information added to the reception data and the group identification information stored in said storage means when the wireless communication terminal is to receive the reception data through said wireless communication means.
